(19) United States
(12) Patent Application Publication
(10) Pub. No.: US 2024/0177909 A1
(43) Pub. Date: May 30, 2024

(54) COIL COMPONENT

(71) Applicant: SAMSUNG ELECTRO-MECHANICS CO., LTD., Suwon-si (KR)

(72) Inventors: Ic Seob KIM, Suwon-si (KR); Seung Ho HAN, Suwon-si (KR); Tai Yon CHO, Suwon-si (KR); In Young KANG, Suwon-si (KR); Seok Hwan AHN, Suwon-si (KR); Sung Hwan PARK, Suwon-si (KR)

(73) Assignee: SAMSUNG ELECTRO-MECHANICS CO., LTD., Suwon-si (KR)

(21) Appl. No.: 18/369,989

(22) Filed: Sep. 19, 2023

(30) Foreign Application Priority Data
Nov. 24, 2022 (KR) 10-2022-0159446
Apr. 6, 2023 (KR) 10-2023-0045600

(51) Int. Cl. H01F 17/00; H01F 27/29

(52) U.S. Cl. CPC H01F 17/0013; H01F 27/292; H01F 2017/002

(57) ABSTRACT

A coil component includes a body including a first surface and a second surface opposing each other, a coil disposed in the body and having a concave portion disposed in a portion of a surface of the coil, an external electrode disposed on the first surface of the body, and a connecting conductor connecting the coil and the external electrode. The connecting conductor includes a filling region disposed in at least a portion of the concave portion of the coil and a tapered region having a side surface inclined with respect to the first surface.

### CROSS-REFERENCE TO RELATED APPLICATION (S)

This application claims benefit of priority to Korean Patent Application No. 10-2022-0159446 filed on Nov. 24, 2022 and Korean Patent Application No. 10-2023-0045600 filed on Apr. 6, 2023 in the Korean Intellectual Property Office, the disclosure of which is incorporated herein by reference in its entirety.

### TECHNICAL FIELD

The present disclosure relates to a coil component.

An inductor, a coil component, is a typical passive electronic component used in electronic devices along with resistors and capacitors.

As electronic devices are gradually miniaturized and become multifunctional and high-performance, inductors are also required to be miniaturized, and at the same time, demand for inductors without capacitance degradation due to miniaturization is increasing.

To significantly reduce the decrease in capacity due to the miniaturization, it is required to significantly increase the volume of the magnetic material in the inductor. In addition, in terms of power consumption efficiency, an inductor having a low DC resistance (R_{dc}) value is required.

### SUMMARY

An aspect of the present disclosure is to provide a coil component having a low DC resistance (Rdc) value.

An aspect of the present disclosure is to provide a coil component having high inductance by significantly reducing loss of a magnetic material.

According to an aspect of the present disclosure, a coil component includes a body including a first surface and a second surface opposing each other, a coil disposed in the body and having a concave portion disposed in a portion of a surface of the coil, an external electrode disposed on the first surface of the body, and a connecting conductor connecting the coil and the external electrode. The connecting conductor includes a filling region disposed in at least a portion of the concave portion of the coil and a tapered region having a side surface inclined with respect to the first surface.

According to an aspect of the present disclosure, a coil component includes a body including a first surface and a second surface opposing each other and a side surface connecting the first surface and the second surface to each other; a coil disposed in the body, and including one or more turns and a lead-out portion extending from an outermost one of the one or more turns to a side surface of the body; an external electrode disposed on the first surface of the body; a via hole disposed in the body and having a width increasing from the lead-out portion to the external electrode; and a connecting conductor disposed in the via hole to connect the coil and the external electrode to each other.

### BRIEF DESCRIPTION OF DRAWINGS

The above and other aspects, features, and advantages of the present disclosure will be more clearly understood from the detailed following description, taken in conjunction with the accompanying drawings, in which:

FIG. 1 is a schematic view of a coil component according to a first embodiment;

FIG. 2 is a perspective view of a disassembled coil viewed from above;

FIG. 3 is a perspective view of the disassembled coil viewed from below;

FIGS. 4 to 6 are views corresponding to a cross-section taken along line I-I′ of FIG. 1 and illustrating various filling structures of a connecting conductor;

FIGS. 7 and 8 are plan views of a coil component according to a modified example, viewed in one direction;

FIGS. 9 to 11 are views corresponding to cross-sections taken along line I-I′ of FIG. 1 as modified examples of the coil component according to the first embodiment;

FIG. 12 is a view corresponding to a cross-section taken along line I-I′ of FIG. 1 as another modified example of the coil component according to the first embodiment;

FIG. 13 is a schematic view of a coil component according to a second embodiment;

FIGS. 14 to 16 are views corresponding to cross-sections taken along line II-II′ of FIG. 11 and illustrating various filling structures of a connecting conductor;

FIG. 17 illustrates a modified example of the coil component according to the second embodiment of FIG. 13 and is a view corresponding to a cross-section taken along line II-II′ in FIG. 13;

FIGS. 18A and 18B each show a view illustrating a connecting conductor of a coil component according to the second embodiment;

FIG. 19 is a schematic view of a coil component according to a third embodiment;

FIGS. 20 to 22 are views corresponding to cross-sections taken along line III-III′ of FIG. 19 and illustrating various filling structures of a connecting conductor; and

FIG. 23 is a modified example of the coil component according to the third embodiment of FIG. 19, and is a view corresponding to a cross-section taken along line III-III′ in FIG. 19.

### DETAILED DESCRIPTION

Hereinafter, embodiments will be described with reference to detailed embodiments and accompanying drawings. However, the embodiments of the present disclosure may be modified in many different forms, and the scope of the present disclosure is not limited to the embodiments described below. In addition, the embodiments of the present disclosure are provided to more completely describe the present disclosure to those skilled in the art. Therefore, the shapes and sizes of elements in the drawings may be exaggerated for clarity of explanation, and elements indicated by the same reference numerals in the drawings are the same elements.

Various types of electronic components are used in electronic devices, and among these electronic components, various types of coil components may be appropriately used for removing noise. For example, in electronic devices, coil components are used as power inductors, HF inductors, general beads, GHz beads, common mode filters, etc.

### First Embodiment

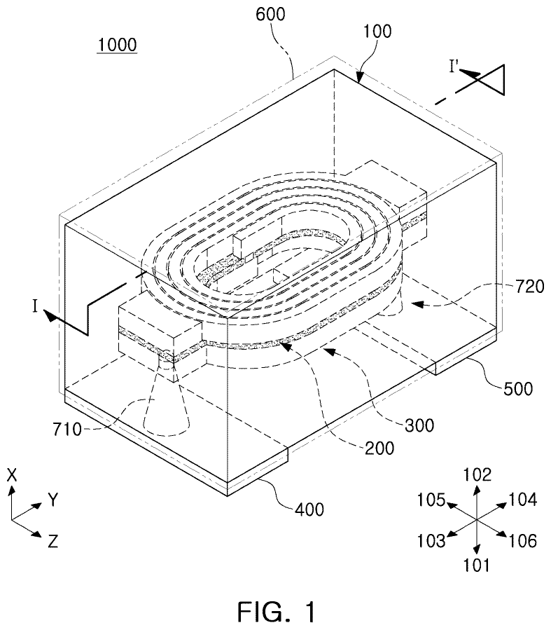

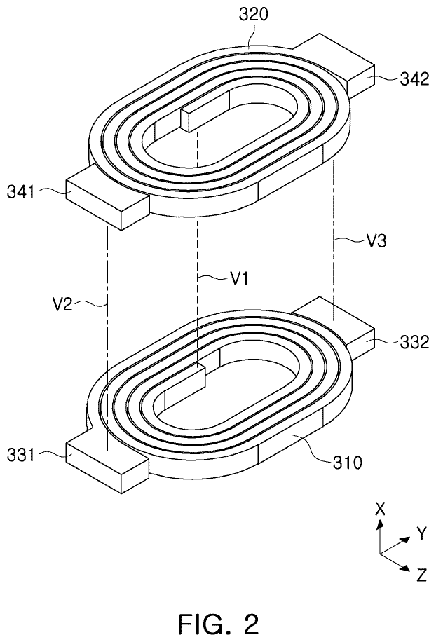

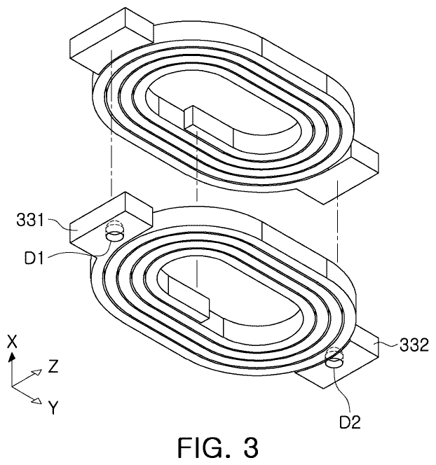

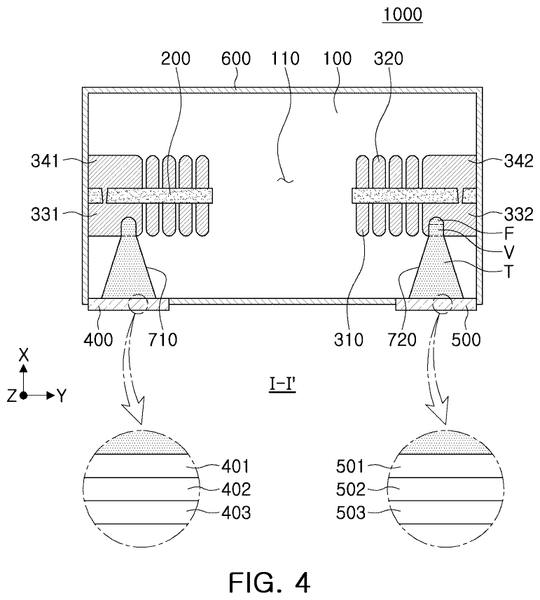

FIG. 1 is a diagram schematically illustrating a coil component according to a first embodiment. FIG. 2 illustrates a disassembled coil and is a perspective view viewed from above. FIG. 3 is a perspective view of the coil of FIG. 2 viewed from below. FIGS. 4 to 6 are views corresponding to the cross-section taken along line I-I′ of FIG. 1 and illustrating various filling structures of the connecting conductor.

Referring to FIGS. 1 to 6, a coil component 1000 according to the present embodiment includes a body 100, a coil 300, external electrodes 400 and 500, and connecting conductors 710 and 720, and may further include a support member 200 and an insulating layer 600. In this case, the connecting conductors 710 and 720 include a filling region F formed in at least portions of the concave portions D1 and D2 of the coil 300, and a tapered region T having an inclined side with respect to the first surface 101 of the body 100. As in the present embodiment, since the connecting conductors 710 and 720 are implemented in a form including the filling region F and the tapered region T, plating may be advantageous during via hole fill plating by adjusting the aspect ratio of the via hole.

The body 100 forms the exterior of the coil component 1000, and the coil 300 and the support member 200 are disposed therein. As illustrated, the body 100 may be formed in the shape of a hexahedron as a whole. The body 100 may include a first surface 101 and a second surface 102 opposing each other in a first direction (X-direction), a third surface 103 and a fourth surface 104 opposing each other in a second direction (Y-direction), and a fifth surface 105 and a sixth surface 106 opposing each other in the third direction (Z-direction). In this case, the second direction (Y-direction) and the third direction (Z-direction) may be perpendicular to the first direction (X-direction). As an example, the body 100 may be formed such that the coil component 1000 according to the present embodiment in which the external electrodes 400 and 500 to be described later are formed may have a length of 2.5 mm, a width of 2.0 mm and a thickness of 1.0 mm, a length of 2.0 mm, a width of 1.2 mm and a thickness of 0.65 mm, a length of 1.6 mm, a width of 0.8 mm and a thickness of 0.8 mm, a length of 1.0 mm, a width of 0.5 mm and a thickness of 0.5 mm, or a length of 0.8 mm, a width of 0.4 mm and a thickness of 0.65 mm, but the present disclosure is not limited thereto. On the other hand, since the above-mentioned numerical values are merely design values that do not reflect process errors, etc., it should be regarded that the range that may be recognized as a process error belongs to the scope of the present disclosure.

The length of the coil component 1000 described above in the first direction (X-direction) may refer to a maximum value among the dimensions of the plurality of respective line segments that respectively connect the two outermost boundary lines facing each other in the first direction (X-direction) of the coil component 1000 illustrated in the cross-sectional image and are parallel to the first direction (X-direction), based on an optical microscope or scanning electron microscope (SEM) image of a cross-section of the coil component 1000 in the first direction (X-direction)-third direction (Z-direction) at the center of the coil component 1000 in the second direction (Y-direction). Alternatively, this length may refer to a minimum value among the dimensions of the plurality of respective line segments that respectively connect the two outermost boundary lines facing each other in the first direction (X-direction) of the coil component 1000 illustrated in the cross-sectional image and are parallel to the first direction (X-direction). Alternatively, this length may refer to at least three arithmetic average values among the dimensions of the plurality of respective line segments that respectively connect the two outermost boundary lines facing each other in the first direction (X-direction) of the coil component 1000 illustrated in the cross-sectional image and are parallel to the first direction (X-direction). In this case, the plurality of line segments parallel to the first direction (X-direction) may be equally spaced from each other in the third direction (Z-direction), but the scope of the present disclosure is not limited thereto.

The length of the coil component 1000 described above, in the second direction (Y-direction), may refer to a maximum value among dimensions of the plurality of respective line segments that respectively connect two outermost boundary lines facing each other in the second direction (Y-direction) of the coil component 1000 illustrated in the cross-sectional image and are parallel to the second direction (Y-direction), based on an optical microscope or scanning electron microscope (SEM) image of a cross-section of the coil component 1000 in the first direction (X-direction)-second direction (Y-direction) at the center of the coil component 1000 in the third direction (Z-direction). Alternatively, this length may refer to a minimum value among dimensions of a plurality of respective line segments that respectively connect two outermost boundary lines facing each other in the second direction (Y-direction) of the coil component 1000 illustrated in the cross-sectional image and are parallel to the second direction (Y-direction).

Alternatively, this length may refer to an arithmetic average value of at least three of dimensions of a plurality of respective line segments that respectively connect two outermost boundary lines facing each other in the second direction (Y-direction) of the coil component 1000 illustrated in the cross-sectional image and are parallel to the second direction (Y-direction). In this case, the plurality of line segments parallel to the second direction (Y-direction) may be equally spaced from each other in the first direction (X-direction), but the scope of the present disclosure is not limited thereto.

The length of the coil component 1000 in the third direction (Z-direction) described above may refer to a maximum value among the dimensions of the plurality of respective line segments that respectively connect the two outermost boundary lines facing each other in the third direction (Z-direction) of the coil component 1000 illustrated in the cross-sectional image and are parallel to the third direction (Z-direction), based on an optical microscope or scanning electron microscope (SEM) image of a cross-section of the coil component 1000 in the first direction (X-direction)-third direction (Z-direction) at the center of the coil component 1000 in the second direction (Y-direction). Alternatively, this length may refer to a minimum value among the dimensions of the plurality of respective line segments that respectively connect the two outermost boundary lines facing each other in the third direction (Z-direction) of the coil component 1000 illustrated in the cross-sectional image and are parallel to the third direction (Z-direction). Alternatively, this length may refer to at least three arithmetic average values among the dimensions of the plurality of respective line segments that respectively connect the two outermost boundary lines facing each other in the third direction (Z-direction) of the coil component 1000 illustrated in the cross-sectional image and are parallel to the third direction (Z-direction). In this case, the plurality of line segments parallel to the third direction (Z-direction) may be equally spaced from each other in the first direction (X-direction), but the scope of the present disclosure is not limited thereto.

On the other hand, each of the lengths of the coil component 1000 in the first to third directions may be measured by a micrometer measurement method. The micrometer measurement method may be performed by setting the zero point with a micrometer with Repeatability and Reproducibility (Gage R&R) and inserting the coil component 1000 according to the present embodiment between the tips of the micrometer and by turning the measuring lever of the micrometer. On the other hand, in measuring the length of the coil component 1000 by the micrometer measurement method, the length of the coil component 1000 may refer to a value measured once or may refer to an arithmetic average of values measured a plurality of times.

The body 100 may include a resin and a magnetic material. In detail, the body 100 may be formed by stacking one or more magnetic composite sheets in which a magnetic material is dispersed in a resin. The magnetic material may be ferrite or metallic magnetic powder. The ferrite may be at least one of, for example, spinel ferrites such as Mg—Zn, Mn—Zn, Mn—Mg, Cu—Zn, Mg—Mn—Sr, Ni—Zn, Ba—Zn, Ba—Mg, etc., hexagonal ferrites such as Ba—Ni, Ba—Co, Ba—Ni—Co, etc., Y-type garnet ferrites, and Li-type ferrites. The metal magnetic powder may include at least one selected from the group consisting of iron (Fe), silicon (Si), chromium (Cr), cobalt (Co), molybdenum (Mo), aluminum (Al), niobium (Nb), copper (Cu), and nickel (Ni). For example, the metal magnetic powder may be at least one of pure iron powder, Fe—Si alloy powder, Fe—Si—Al alloy powder, Fe—Ni alloy powder, Fe—Ni—Mo alloy powder, Fe—Ni—Mo—Cu alloy powder, Fe—Co alloy powder Alloy powder, Fe—Ni—Co alloy powder, Fe—Cr alloy powder, Fe—Cr—Si alloy powder, Fe—Si—Cu—Nb alloy powder, Fe—Ni—Cr alloy powder, and Fe—Cr—Al alloy powder. The magnetic metal powder may be amorphous or crystalline. For example, the magnetic metal powder may be Fe—Si—B—Cr-based amorphous alloy powder, but is not necessarily limited thereto. Each of the ferrite and magnetic metal powder may have an average diameter of about 0.1 μm to about 30 μm, but the present disclosure is not limited thereto. The body 100 may include two or more types of magnetic materials dispersed in resin. In this case, when the magnetic materials are of different types, it means that the magnetic materials dispersed in the resin are distinguished from each other by one of average diameter, composition, crystallinity, and shape. For example, as the magnetic material, a plurality of types of magnetic metal powders having different sizes may be used. In detail, the first to third magnetic metal powders may have first to third diameter ranges, respectively. In this case, the first diameter range may be 5-61 μm, the second diameter range may be 0.6-4.5 μm, and the third diameter range may be 10-900 nm. On the other hand, hereinafter, a description will be made on the premise that the magnetic material is a metal magnetic powder, but the scope of the present disclosure does not extend only to the body 100 having a structure in which the metal magnetic powder is dispersed in a resin. The resin may include epoxy, polyimide, liquid crystal polymer, etc., alone or in combination, but is not limited thereto.

The body 100 includes a core 110 passing through a coil 300 to be described later. The core 110 may be formed by filling through-holes of the coil 300 with a magnetic composite sheet, but the present disclosure is not limited thereto.

The coil component 1000 according to the present embodiment may further include a support member 200. The support member 200 is disposed within the body 100 and may support the coil 300. The support member 200 has one surface (the lower surface based on the drawings in the case of the present embodiment) facing the first surface 101 and the other surface (the upper surface based on the drawing in the case of the present embodiment) facing the second surface 102 of the body 100.

The support member 200 is formed of an insulating material including a thermosetting insulating resin such as epoxy resin, a thermoplastic insulating resin such as polyimide, or a photosensitive insulating resin, or may be formed of an insulating material impregnated with a reinforcing material such as glass fiber or inorganic filler in the insulating resin. For example, the support member 200 may be formed of an insulating material such as prepreg, Ajinomoto Build-up Film (ABF), FR-4, Bismaleimide Triazine (BT) resin, Photo Imageable Dielectric (PID), etc., but is not limited thereto. The example of the inorganic filler may include at least one selected from the group consisting of silica (silicon dioxide, SiO₂), alumina (aluminum oxide, Al₂O₃), silicon carbide (SiC), barium sulfate (BaSO₄), talc, mud, mica powder, aluminum hydroxide (Al(OH)₃), magnesium hydroxide (Mg(OH)₂), calcium carbonate (CaCO₃), magnesium carbonate (MgCO₃), magnesium oxide (MgO), boron nitride (BN), aluminum borate (ALBO₃), barium titanate (BaTiO₃) and calcium zirconate (CaZrO₃). When the support member 200 is formed of an insulating material including a reinforcing material, the support member 200 may provide superior rigidity. When the support member 200 is formed of an insulating material that does not contain glass fibers, it may be advantageous to reduce the thickness of the coil component 1000 according to the present embodiment. In addition, the volume occupied by the coil 300 and/or the magnetic metal powder may be increased based on the body 100 having the same size, so that component characteristics may be improved. When the support member 200 is formed of an insulating material including a photosensitive insulating resin, the number of processes for forming the coil 300 is reduced, which may be advantageous in reducing production costs. The thickness of the support member 200 may be, for example, 10 μm or more and 50 μm or less, but is not limited thereto.

The coil 300 is disposed within the body 100. In detail, the coil 300 may include a first coil 310 disposed on one surface (the lower surface based on the drawing in the case of the present embodiment) of the support member 200, and a second coil 320 disposed on the other surface (the upper surface based on the drawings in the case of the present embodiment) of the support member 200. Hereinafter, the structure of the coil will be described with reference to FIGS. 1 to 3.

FIG. 2 illustrates a disassembled coil and is a perspective view viewed from above.

The coil 300 may include a first coil 310, a first lead-out portion 331, and a second lead portion 332, disposed on one surface of the support member 200.

The coil 300 may include a second coil 320 and a second auxiliary lead-out portion 342 disposed on the other surface of the support member 200.

The first coil 310 and the second coil 320 form one or more turns around the core 110 and may have a planar spiral shape. However, the present disclosure is not limited thereto, and the first coil 310 and the second coil 320 may also have an angular shape.

Referring to FIG. 2, on the lower surface of the support member 200, the first coil 310 is connected to and in contact with the first lead-out portion 331, and the first coil 310 and the first lead-out portion 331 are spaced apart from the second lead-out portion 332. In addition, on the upper surface of the support member 200, the second coil 320 is connected to be in contact with the second auxiliary lead-out portion 342, and the second coil 320 and the second auxiliary lead-out portion 342 are spaced apart from the first auxiliary lead-out portion 341. For example, the first coil 310 is connected to the first lead-out portion 331, and the second coil 320 is connected to the second lead-out portion 332 through the second auxiliary lead-out portion 342. On the other hand, the first auxiliary lead-out portion 341 is irrelevant to the electrical connection between the remaining components of the coil 300, and may thus be omitted in the present disclosure. In the case of an asymmetric structure in which the auxiliary lead-out portion 340 is formed on only one side of the body 100, the effective volume of the body 100 increases and the inductance characteristics may be improved.

The first via V1 passes through the support member 200 and contacts the first coil 310 and the second coil 320, respectively. For example, one region of the innermost turn of the first coil 310 and one region of the innermost turn of the second coil 320 may be connected. The second via V2 penetrates the support member 200 and contacts the first lead-out portion 331 and the first auxiliary lead portion 341, respectively. The third via V3 penetrates the support member 200 and contacts the second lead-out portion 332 and the second auxiliary lead-out portion 342, respectively. Therefore, the coil 300 may function as a single coil as a whole.

The lead-out portions 331 and 332 and the auxiliary lead-out portions 341 and 342 may extend to the third surface 103 and the fourth surface 104 facing each other in the second direction (Y-direction) of the body 100. In detail, the first pullout 331 and the first auxiliary lead-out portion 341 may extend to the third surface 103 of the body 100, and the second lead-out portion 332 and the second auxiliary lead-out portion 342 may extend to the fourth surface 104 of the body 100.

FIG. 3 is a perspective view of the coil of FIG. 2 viewed from below.

Referring to FIG. 3, concave portions D1 and D2 are formed on a portion of the surface of the coil 300. In detail, the concave portions D1 and D2 are formed on portions of the surfaces (the lower surface based on the drawing in the case of the present embodiment) of the coil 300 facing the first surface 101 of the body 100. The concave portions D1 and D2 may be formed by penetrating a portion of the coil 300 when a via hole is processed in the body 100 using a laser or the like. For example, the concave portions D1 and D2 may be formed in the surface of the coil 300 during processing of the via hole. Accordingly, a portion of one surface of the coil 300 may be more recessed into the coil 300 than the remainder thereof.

The coil 300 may include a first lead-out portion 331 disposed on one side of the support member 200, connected to the first coil 310, and having a first concave portion D1, and a second lead-out portion 332 disposed on one surface of the support member 200, connected to the second coil 320, and having a second concave portion D2.

As will be described later, the coil 300 and the external electrodes 400 and 500 may be connected by filling at least a portion of the concave portions D1 and D2 of the coil 300 to form the connecting conductors 710 and 720. In detail, the concave portions D1 and D2 may be filled by the filling region F and the vertical region V of the connecting conductors 710 and 720.

At least one of the components constituting the coil 300 may include one or more conductive layers. For example, when the coil 300 is formed by applying a plating process to the surface of the support member 200, at least one of the components constituting the coil 300 may include a first conductive layer formed by electroless plating or the like, and a second conductive layer disposed on the first conductive layer. The first conductive layer may be a seed layer for forming the second conductive layer on the support member 200 by plating, and the second conductive layer may be an electrolytic layer. In this case, the electrolytic plating layer may have a single-layer structure or a multilayer structure. The electrolytic layer of the multilayer structure may be formed in a conformal film structure in which one electrolytic layer is covered by another electrolytic layer, and may also be formed in a shape in which another electrolytic layer is laminated on only one surface of one electrolytic layer. The coil 300 may be formed of a conductive material such as copper (Cu), aluminum (Al), silver (Ag), tin (Sn), gold (Au), nickel (Ni), lead (Pb), titanium (Ti), or alloys thereof, but is not limited thereto.

Although not illustrated in the drawings, an insulating layer may be formed on the surface of the coil 300. The insulating layer may integrally cover the coil 300 and the support member 200. In detail, the insulating layer may be disposed between the coil 300 and the body 100 and between the support member 200 and the body 100. The insulating layer may be formed along the surface of the support member 200 on which the coil 300 is formed, but the present disclosure is not limited thereto. The insulating layer is for electrically separating the coil 300 and the body 100, and may include a known insulating material such as parylene, but is not limited thereto. As another example, the insulating layer may include an insulating material such as an epoxy resin other than parylene. The insulating layer may be formed by vapor deposition, but is not limited thereto. As another example, the insulating layer may be formed by laminating and curing an insulating film for forming the insulating layer, on both surfaces of the support member 200 on which the coil 300 is formed, and may also be formed by applying and curing an insulating paste for forming the insulating layer on both surfaces of the support member 200 on which the coil 300 is formed. On the other hand, for the reasons described above, the insulating layer is a component that may be omitted in the present embodiment. For example, if the body 100 has sufficient electrical resistance at the designed operating current and voltage of the coil component 1000, the insulating layer may be omitted in the present embodiment.

The external electrodes 400 and 500 are disposed on the first surface 101 of the body 100. The external electrodes 400 and 500 may be disposed only on the first surface 101 of the body 100 as illustrated. Unlike this, portions of the external electrodes 400 and 500 may also be disposed on at least portions of the side surfaces of the body 100, for example, the third to sixth surfaces 103 to 106. The external electrodes may include first and second external electrodes 400 and 500 respectively connected to the first and second coils 310 and 320. In detail, the first and second external electrodes 400 and 500 are disposed spaced apart from each other on the first surface 101 of the body 100, and are connected to the coil 300 through connecting conductors 710 and 720 to be described later. When the coil component 1000 is mounted on an electronic device or the like, the first and second external electrodes 400 and 500 may serve to electrically connect the coil 300 in the coil component 1000 to the electronic device.

The first and second external electrodes 400 and 500 may be formed of a conductive material of copper (Cu), aluminum (Al), silver (Ag), tin (Sn), gold (Au), nickel (Ni), lead (Pb), chromium (Cr), titanium (Ti), alloys thereof, or the like, but the present disclosure is not limited thereto. The first and second external electrodes 400 and 500 may be formed in a multilayer structure. For example, the first and second external electrodes 400 and 500 may be formed as a single layer, or may be implemented as a multilayer structure as illustrated in FIG. 4. In detail, the external electrodes 400 and 500 may include first conductive layers 401 and 501 including at least one of copper (Cu) and silver (Ag), second conductive layers 402 and 502 disposed on the first conductive layers 401 and 501 and containing nickel (Ni), and third conductive layers 403 and 503 disposed on the second conductive layers 402 and 403 and including tin (Sn). The first conductive layers 401 and 501 may be plating layers or conductive resin layers formed by applying and curing a conductive resin containing conductive powder containing at least one of copper (Cu) and silver (Ag) and a resin. The second conductive layers 402 and 502 and the third conductive layers 403 and 503 may be plating layers, but the scope of the present disclosure is not limited thereto. In addition, the first conductive layer 410 may include a plurality of the above-described conductive resin layers as needed for securing reliability.

The coil component 1000 according to the present embodiment may further include an insulating layer 600 covering the outer surface of the body 100 and disposed to expose the first and second external electrodes 400 and 500 disposed on the first surface 101, for example, the mounting surface. The insulating layer 600 may be formed by, for example, coating and curing an insulating material containing an insulating resin on the surface of the body 100. In this case, the insulating layer 600 may include at least one of a thermoplastic resin such as polystyrene, vinyl acetate, polyester, polyethylene, polypropylene, polyamide, rubber, and acrylic, a thermosetting resin such as phenol-based, epoxy-based, urethane-based, melamine-based, and alkyd-based resins, and a photosensitive insulating resin.

The connecting conductors 710 and 720 pass through a portion of the body 100 to connect the coil 300 and the external electrodes 400 and 500. One ends of the connecting conductors 710 and 720 extend from the first surface 101 of the body 100 and are connected to the external electrodes 400 and 500 disposed on the first surface 101, and the other end thereof is connected to the coil 300. By connecting the coil 300 and the external electrodes 400 and 500 with the connecting conductors 710 and 720 in this manner, a coil component having a high inductance by significantly reducing the loss of the magnetic body may be implemented.

The connecting conductors 710 and 720 may include a first connecting conductor 710 connecting the first lead-out portion 331 and the first external electrode 400, and a second connecting conductor 720 connecting the second lead-out portion 332 and the second external electrode 500.

As will be described below, the connecting conductors 710 and 720 may be formed by irradiating the body 100 and the coil 300 with a laser or the like to process a via hole and then fill-plating the via hole. When a via hole is processed by laser drilling, the shape of the via hole may vary. In detail, the via hole may have a side surface inclined with respect to the first surface 101 of the body 100, may have a side surface substantially perpendicular to the first surface 101 of the body 100, or may have a curved surface. Alternatively, the via hole may include a first side surface and a second side surface having different inclination angles with respect to the first surface 101 of the body 100.

The connecting conductors 710 and 720 may be formed by fill-plating via holes. In this case, the connecting conductors 710 and 720 may have substantially the same shape as the via hole. For example, the connecting conductors 710 and 720 may be vias obtained by plating a via hole. Hereinafter, the shape and filling structure of the connecting conductors 710 and 720 will be described in detail with reference to FIGS. 4 to 6.

FIGS. 4 to 6 are views corresponding to the cross-section taken along line I-I′ of FIG. 1 and illustrating various filling structures of the connecting conductor.

As described above, the connecting conductors 710 and 720 may include a filling region F filled in at least portions of the concave portions D1 and D2 of the coil 300, and a tapered region T having a side surface inclined with respect to the first surface 101 of the body 100. The tapered region T and the vertical region V, which will be described below, may be formed by filling via holes with fill plating, similarly to the filling region F. In order to distinguish from the filling region F, it is referred to as the tapered region T and the vertical region V as above.

The filling region F may fill at least portions of the concave portions D1 and D2 of the coil 300. As described above, since the concave portions D1 and D2 may include the first concave portion D1 formed on the first lead-out portion 331 and the second concave portion D2 formed on the second lead-out portion 332, respective filling regions (F) of the connecting conductors 710 and 720 may fill at least portions of the first and second concave portions D1 and D2.

Side surfaces of the connecting conductors 710 and 720 constituting the tapered region T are inclined with respect to the first surface 101 of the body 100. Accordingly, the cross-sections of the tapered region T, parallel to the first surface 101, may gradually increase or decrease in the first direction. Accordingly, as illustrated, a portion of the tapered region T may deviate from the lead-out portions D1 and D2 without overlapping therewith in the first direction (X-direction). The tapered region T may extend to the first surface 101 of the body 100 and be connected to the external electrodes 400 and 500. One aspect of the present embodiment is to adjust the aspect ratio of the via hole so that plating is advantageous during via hole fill plating. The via hole may be formed with various aspect ratios. The higher the aspect ratio is, the more defects such as voids during plating increase, and thus, it may be more difficult to perform fill plating. In detail, when the aspect ratio is relatively high, the depth of the via hole increases. Thus, since it is difficult for the plating solution to circulate inside the via hole, the occurrence of defects during fill plating increases. Accordingly, in the present embodiment, since a via hole having a tapered side surface is introduced, fill plating may be smoothly performed even when a via hole having a high aspect ratio is formed. On the other hand, the side of the tapered region T does not necessarily have only one inclination angle, and the tapered region T may be implemented in a shape having a plurality of inclination angles, and may further include a curved area.

The connecting conductors 710 and 720 may include a vertical region V having a side surface perpendicular to the first surface 101 of the body 100. In this case, the meaning of ‘perpendicular’ includes the case in which the side surfaces of the connecting conductors 710 and 720 and the first surface 101 form a substantially right angle. Accordingly, the areas of the cross-sections parallel to the first surface 101 in the vertical region V may be substantially the same. However, the side surface of the vertical region V does not have to be perfectly perpendicular to the first surface 101, and when looking at the side surface of the vertical region V as a whole, it means that the side surface of the vertical region V is substantially perpendicular to the first surface 101. Therefore, as in the case in which the surfaces of the connecting conductors 710 and 720 have a high level of roughness, for example, some non-vertical regions may be included on the side surface of the vertical region V. The vertical region V may be disposed between the filling region F and the tapered region T to connect the filling region F and the tapered region T. For example, a via hole having a high aspect ratio may be designed by the vertical region V, and in this case, the plating solution may be smoothly circulated into the via hole through the tapered region T.

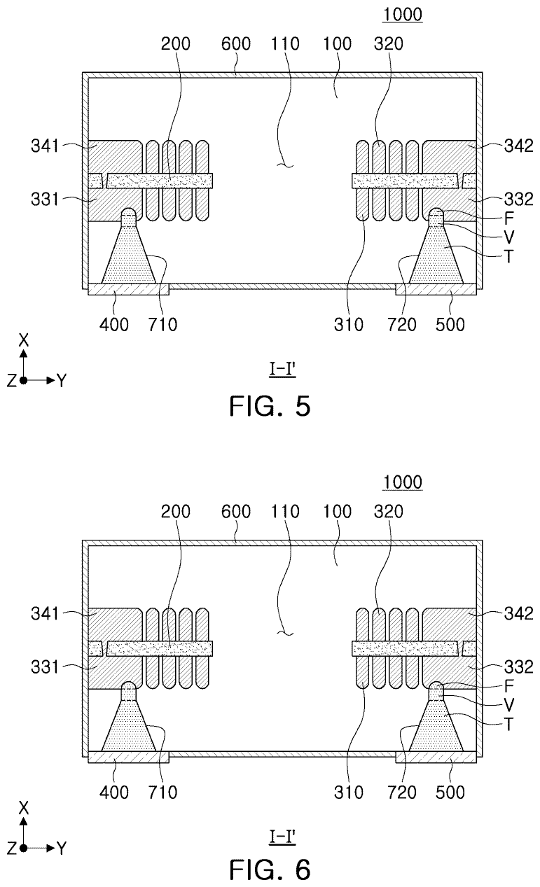

Referring to FIGS. 4 and 5, at least a portion of the vertical region V may be disposed in the concave portions D1 and D2. In this case, at least a portion of the vertical region V contacts the concave portions D1 and D2. For example, at least a portion of the vertical region V may fill the concave portions D1 and D2. FIG. 4 is a view illustrating that the entirety of the vertical region V is disposed in the concave portions D1 and D2, and FIG. 5 is a diagram illustrating that a portion of the vertical region V is disposed in the concave portions D1 and D2. However, the present disclosure is not limited thereto, and the vertical region V may not be disposed in the concave portions D1 and D2.

Referring to FIG. 6, the vertical region V may not contact the concave portions D1 and D2 of the coil 300. For example, the vertical region V may not fill the concave portions D1 and D2 of the coil 300.

The connecting conductors 710 and 720 may include a curved surface, and the curved surface may form a portion of the aforementioned filling region F. For example, the curved surfaces of the connecting conductors 710 and 720 may contact the concave portions D1 and D2 of the coil 300.

The filling structure of the connecting conductors 710 and 720 of the coil component 1000 according to the first embodiment may be confirmed as follows. In cross-sections in the first direction (X-direction) and second direction (Y-direction) of the coil component, cross-section samples penetrating the connecting conductors 710 and 720 are taken. The concave portions D1 and D2 of the coil 300 may form a portion of a via hole, and the concave portions D1 and D2 are located in the filling region F and the vertical region V of the connecting conductors 710 and 720. Therefore, a boundary is formed between the concave portions D1 and D2 of the coil and the connecting conductors 710 and 720. The filled structure may be confirmed by observing the boundary of the collected cross-sectional sample with an optical microscope or a scanning electron microscope (SEM) image.

The aspect ratio of the tapered via hole may be designed as follows. When the average value of the maximum diameter and the minimum diameter of the cross-section parallel to the first surface 101 in the tapered region T of the connecting conductors 710 and 720 is referred to as ‘a’ and the length c of the tapered region T in the first direction is referred to as ‘c’, c/a may be 0.18 or more and 12.25 or less. The maximum diameter may be the diameter of the cross-section of the tapered region T extending to the first surface 101 of the body, and the minimum diameter may be the diameter of the cross-section at the point where the tapered region T meets the vertical region (or the filling region).

The diameters of the connecting conductors 710 and 720 of the coil component 1000 according to the present embodiment may be measured as follows. Among cross-sections of the coil component in the first direction (X-direction) and second direction (Y-direction), cross-section samples passing through the centers of the connecting conductors 710 and 720 are taken. In detail, since the tapered region T is shaped like a truncated cone, one end surface and the other end surface of the tapered region parallel to the first surface 101 of the body on both ends thereof in the first direction may have a circular shape. A cross-section passing through the center of the connecting conductors 710 and 720 refers to a cross-section passing through the center of one end surface and the other end surface (circle) of the connecting conductors 710 and 720. The diameter of the circle may be obtained by analyzing the collected cross-sectional sample with an optical microscope or a scanning electron microscope (SEM) image. ‘a’ may be the arithmetic average of the values of the maximum and minimum diameters of the measured circles.

The length of the tapered region T of the coil component 1000 according to the present embodiment, in the first direction, may be obtained by taking a cross-section sample passing through the center of the connecting conductors 710 and 720 among the first-direction (X-direction)-second-direction (Y-direction) cross-sections of the coil component described above and by measuring the distance between one end surface and the other end surface of the connecting conductors 710 and 720 with an optical microscope or Scanning Electron Microscope (SEM) image of the cross-section sample taken.

The first connecting conductor 710 may be connected to the first lead-out portion 331 at an inner side further than the center line of the first lead-out portion 331, based on the direction (second direction) from the first lead-out portion 331 to the second lead-out portion 332, and in this case, the location of the first connecting conductor 710 may be an area corresponding to the center of the first concave portion D1. Similarly, the second connecting conductor 720 may be connected to the second lead-out portion 332 at an inner side further than the center line of the second lead-out portion 332 based on the direction (second direction) from the second lead-out portion 332 toward the first lead-out portion 331. In this case, the location of the second connecting conductor 720 may be an area corresponding to the center of the second concave portion D2. For example, the first and second connecting conductors 710 and 720 may not be disposed in the center of the lead-out portions 331 and 332, but may be disposed biased toward the inside of the coil component 1000.

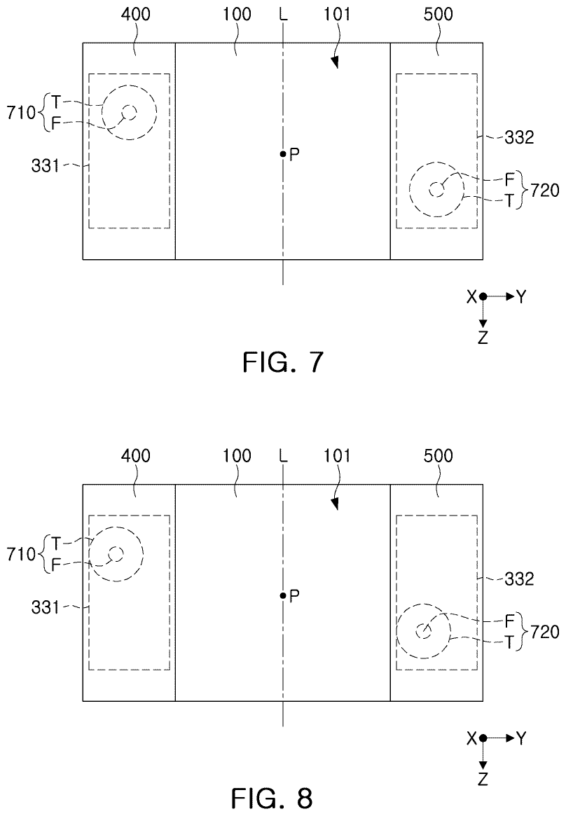

The first and second connecting conductors 710 and 720 may be disposed in positions forming a symmetrical structure. For example, referring to FIGS. 7 and 8, FIGS. 7 and 8 correspond to a plan view of the coil component according to the modified example viewed from one direction (a plan view viewed from below with reference to FIG. 1). First, referring to FIG. 7, in a case in which the first and second connecting conductors 710 and 720 face each other in the second direction (Y-direction), the first and second connecting conductors 710 and 720 on one surface parallel to the first surface 101 of the body 100 may have a symmetrical structure with respect to the center point P of the one surface or the center line L perpendicular to the second direction (Y-direction). In this case, the symmetrical form with respect to the center line (L) of the one surface corresponds to the form in the embodiment of FIG. 1. Next, referring to FIG. 8, due to errors in the process or the like, the first and second connecting conductors 710 and 720 on one surface parallel to the first surface 101 of the body 100 may have an asymmetrical structure with respect to the center point (P) of the one surface or the center line (L) perpendicular to the second direction (Y-direction).

A method of forming the connecting conductors 710 and 720 is as follows. First, via holes are processed in the body 100 and the coil 300 by laser drilling, mechanical drilling, or the like. For example, a via hole may be formed using two or more types of lasers having different processing widths. First, a via hole having an inclined side surface is processed by irradiating a laser having a relatively large processing width, and then a via hole having a vertical or inclined side surface is processed using a laser having a small processing width. Then, fill plating, for example, a conductive material may be filled in the formed via hole.

Accordingly, the connecting conductors 710 and 720 may be fill-plated vias and may include a plating layer. The plating layer of the connecting conductors 710 and 720 may include copper (Cu), but is not limited thereto.

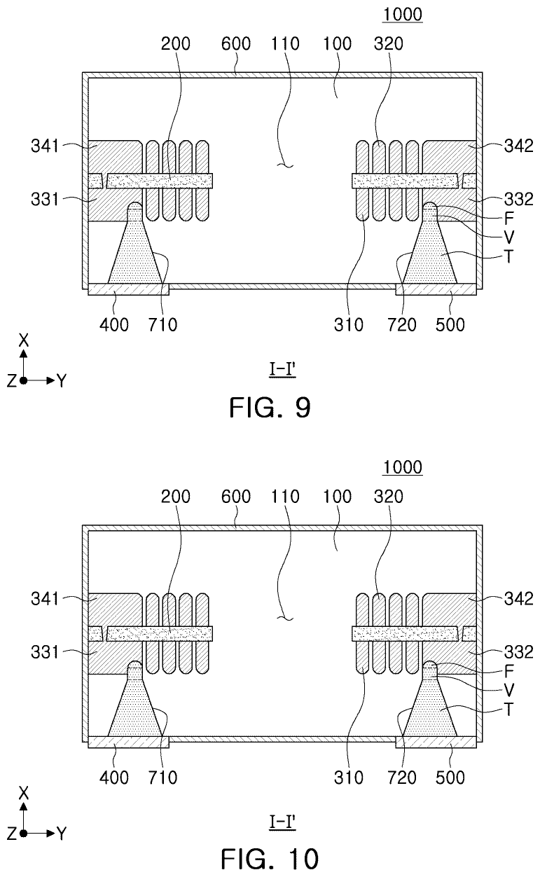

FIGS. 9 to 11 are views corresponding to a cross-section taken along line I-I′ of FIG. 1, as a modified example of the coil component according to the first embodiment.

As will be described below, since Rdc tends to decrease as the connecting conductors 710 and 720 are disposed more inwardly of the coil component, the connecting conductors 710 and 720 may come into contact with the inner side surfaces of the lead-out portions 331 and 332 as illustrated in FIGS. 9 to 11.

In detail, referring to FIGS. 9 to 11, the first connecting conductor 710 is connected to the side of the first lead-out portion 331, facing the inner turn of the first coil 310, and the second connecting conductor 720 may be connected to the side of the second lead-out portion 332, facing the first coil 310. In this case, inductor characteristics with a relatively lower DC resistance (Rdc) may be implemented.

Tables 1 and 2 below are tables comparing inductor characteristics with those of a general bottom electrode inductor without forming a via (connecting conductor) when the connecting conductors 710 and 720 having a tapered region (T) are formed.

Table 1 below illustrates comparison of inductor characteristics according to the processing position of the connecting conductors 710 and 720 and the length c of the tapered region T in the first direction with respect to the 1412 0.33 μH model. In this case, 1412 corresponds to a coil component having length, width, and height of 1.4 mm, 1.2 mm, and 0.8 mm, respectively.

TABLE 1

| | | | | Connecting | | | | |
|---|---|---|---|---|---|---|---|---|
| | | | | Conductor | AC | DC | | |
| | | | c | Location | Lₛ @1 Mhz | R_{dc} | Iₛₐₜ | Lₛ |
| Size | Inductance | Electrode | (μm) | (μm) | (μH) | (mohm) | (A) | (μH) |
| 1412 | R33 | Bottom | — | — | 0.3012 | 17.06 | 5.65 | 0.303 |
| | | Electrode | | | | | | |
| | | Connecting | 32.5 | Outside | 0.3049 | 21.29 | 5.65 | 0.3061 |
| | | Conductor | | 50 | | | | |
| | | | | Outside | 0.3046 | 17.68 | — | 0.306 |
| | | | | 25 | | | | |
| | | | | 0 | 0.3044 | 17.04 | 5.64 | 0.3056 |
| | | | | Inside | 0.3041 | 16.79 | — | 0.3054 |
| | | | | 25 | | | | |
| | | | | Inside | 0.3037 | 16.64 | 5.62 | 0.305 |
| | | | | 50 | | | | |
| | | | 65 | Outside | 0.3048 | 20.4 | 5.63 | 0.3058 |
| | | | | 50 | | | | |
| | | | | Outside | 0.3046 | 17.54 | — | 0.3058 |
| | | | | 25 | | | | |
| | | | | 0 | 0.3043 | 17.03 | 5.62 | 0.3057 |
| | | | | Inside | 0.304 | 16.73 | — | 0.3053 |
| | | | | 25 | | | | |
| | | | | Inside | 0.3035 | 16.64 | 6.63 | 0.3048 |
| | | | | 50 | | | | |
| | | | 130 | Outside | 0.3047 | 18.73 | 5.64 | 0.306 |
| | | | | 50 | | | | |
| | | | | Outside | 0.3042 | 17.23 | — | 0.3058 |
| | | | | 25 | | | | |
| | | | | 0 | 0.3041 | 16.89 | 5.65 | 0.3054 |
| | | | | Inside | 0.3037 | 16.69 | — | 0.305 |
| | | | | 25 | | | | |
| | | | | Inside | 0.303 | 16.57 | 5.62 | 0.3044 |
| | | | | 50 | | | | |

Table 2 below illustrates comparison of inductor characteristics according to the processing position of the connecting conductors 710 and 720 and the length c of the tapered region T in the first direction with respect to the 0804 0.68 μH model. In this case, 0804 corresponds to coil components with length, width, and height of 0.8 mm, 0.4 mm, and 0.65 mm, respectively.

TABLE 2

| | | | | Connecting | | | | |
|---|---|---|---|---|---|---|---|---|
| | | | | Conductor | AC | DC | | |
| | | | c | Location | Lₛ @1 Mhz | R_{dc} | Iₛₐₜ | Lₛ |
| Size | Inductance | Electrode | (μm) | (μm) | (μH) | (mohm) | (A) | (μH) |
| 0804 | R68 | Bottom | — | — | 0.6378 | 326.27 | 0.8599 | 0.6397 |
| | | Electrode | | | | | | |
| | | Connecting | 37.5 | Outside | 0.6548 | 330.8 | 0.8419 | 0.6562 |
| | | Conductor | | 50 | | | | |
| | | | | Outside | 0.6539 | 326.69 | 0.8427 | 0.6553 |
| | | | | 25 | | | | |
| | | | | 0 | 0.6524 | 325.79 | 0.8447 | 0.6539 |
| | | | | Inside | 0.6499 | 325.38 | 0.8472 | 0.6515 |
| | | | | 24 | | | | |
| | | | | — | — | — | — | — |
| | | | 75 | Outside | 0.6546 | 330.12 | 0.8412 | 0.6555 |
| | | | | 50 | | | | |
| | | | | Outside | 0.6537 | 326.49 | 0.8428 | 0.6551 |
| | | | | 25 | | | | |
| | | | | 0 | 0.6521 | 325.72 | 0.8441 | 0.6536 |
| | | | | Inside | 0.6494 | 325.35 | 0.8476 | 0.6504 |
| | | | | 24 | | | | |
| | | | | — | — | — | — | — |
| | | | 150 | Outside | 0.6543 | 328.12 | 0.8413 | 0.6559 |
| | | | | 50 | | | | |
| | | | | Outside | 0.653 | 326.08 | 0.843 | 0.6539 |
| | | | | 25 | | | | |
| | | | | 0 | 0.6508 | 325.57 | 0.8465 | 0.6524 |
| | | | | Inside | 0.6475 | 325.23 | 0.8503 | 0.6492 |
| | | | | 24 | | | | |
| | | | | — | — | — | — | — |

Referring to Tables 1 and 2, when forming the connecting conductors 710 and 720, the inductance has a larger value than a value of the bottom electrode inductor. In addition, as the connecting conductors 710 and 720 move toward the inner side of the electronic component, the DC resistance (Rdc) tends to decrease.

FIG. 12 is a view corresponding to a cross-section taken along line I-I′ of FIG. 1 as another modified example of the coil component according to the first embodiment.

Referring to FIG. 12, the filling region F may include a first side surface inclined with respect to the first surface 101 of the body 100, and the tapered region T may include a second side surface inclined with respect to the first surface 101 of the body 100. For example, the side surface of the filling region F may not be a curved surface having a curvature, and may have a predetermined inclination angle from the first surface 101 of the body 100.

The first side surface and the second side surface may have different inclinations with respect to the first surface 101 of the body 100. By forming the via hole with different inclination angles, the plating solution in the via hole may be smoothly circulated, and a via hole having a high aspect ratio may be implemented.

The first side surface may have a lower slope with respect to the first surface 101 of the body 100 than a slope of the second side surface.

The inclination angle of the side surfaces of the connecting conductors 710 and 720 of the coil component 1000 according to the present embodiment may be measured as follows. Among cross-sections of the coil component in the first direction (X-direction) and second direction (Y-direction), cross-section samples passing through the centers of the connecting conductors 710 and 720 are taken. In detail, since the tapered region T is shaped like a truncated cone, one end surface and the other end surface of the tapered region, parallel to the first surface 101 of the body, on both ends thereof in the first direction, are circular. A cross-section passing through the center of the connecting conductors 710 and 720 refers to a cross-section passing through the center of one end surface and the other end surface (circle) of the connecting conductors 710 and 720. The angle of inclination may be obtained by measuring the angle formed by the first surface 101 of the body and the side surfaces of the connecting conductors 710 and 720 using an optical microscope or a scanning electron microscope (SEM) image of the sample taken.

### Second Embodiment

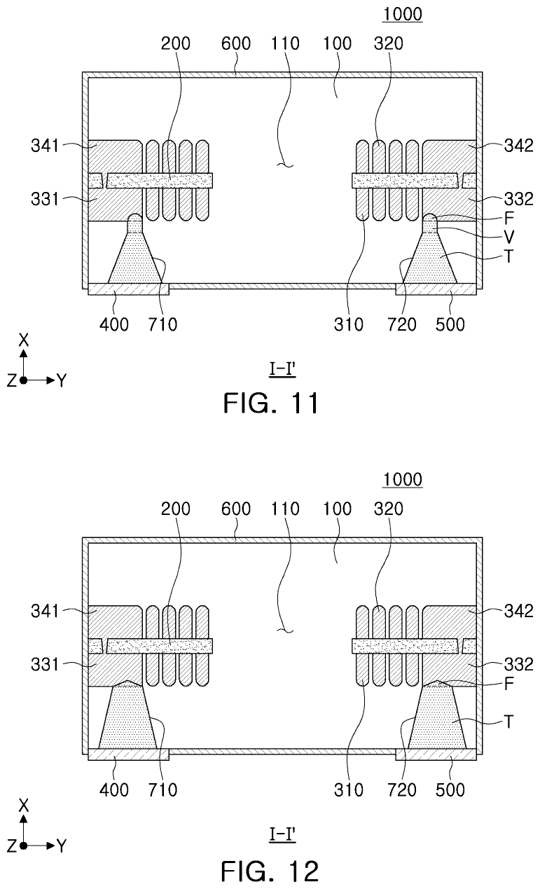

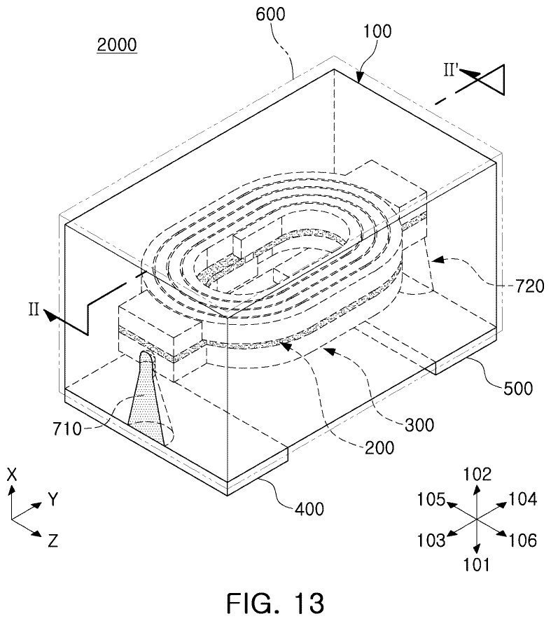

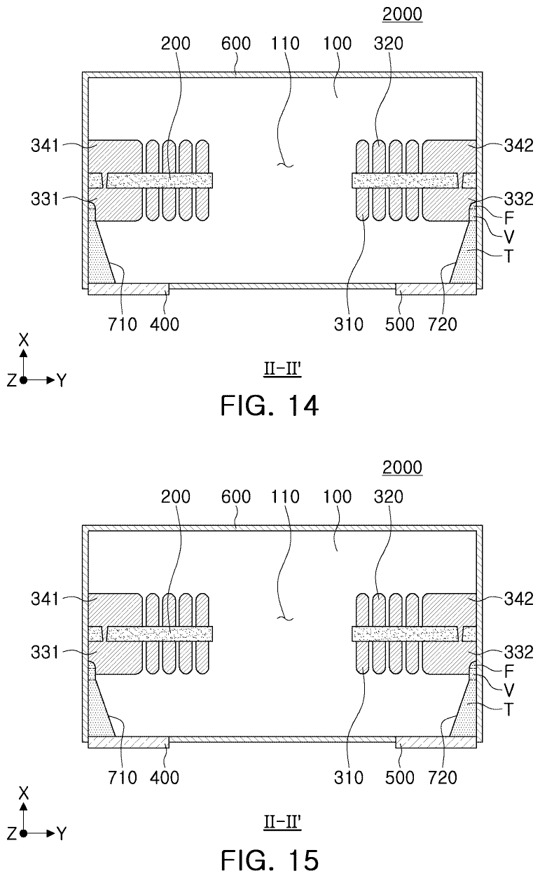

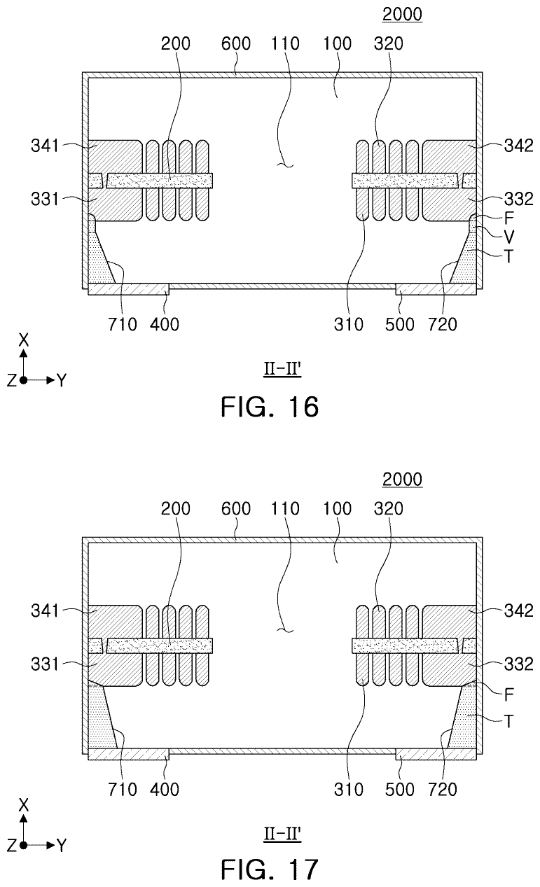

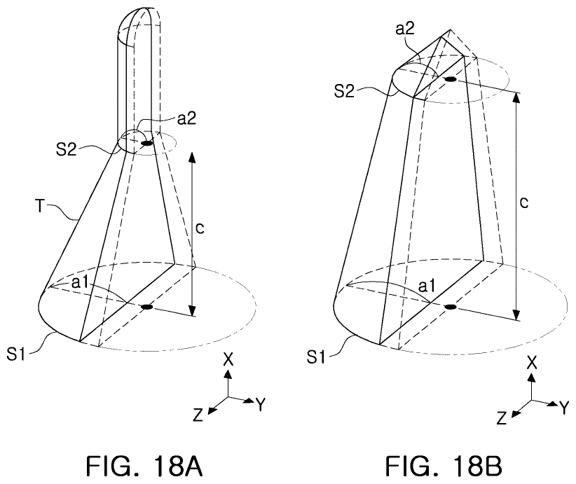

FIG. 13 is a schematic view of a coil component according to a second embodiment. FIGS. 14 to 16 are views corresponding to the cross-section taken along the line II-II′ of FIG. 11 and illustrating various filling structures of the connecting conductor. FIG. 17 is a modified example of the coil component according to the second embodiment of FIG. 13, and is a view corresponding to a cross-section taken along line II-II′ of FIG. 13. FIG. 18 is a view illustrating a connecting conductor of a coil component according to the second embodiment.

Hereinafter, a coil component 2000 according to the second embodiment will be described with reference to FIGS. 13 to 18, and differences from the coil component 1000 according to the first embodiment will be described in detail.

One side surface of the connecting conductors 710 and 720 of the coil component 2000 according to the second embodiment extends to the third surface 103 or the fourth surface 104 of the body 100. In detail, the first connecting conductor 710 extends to the third surface 103 of the body 100, and the second connecting conductor 720 extends to the fourth surface 104 of the body 100. This is a design for reducing the number of via holes processed, and may be a result of the cutting of the fill-plated vias. For example, the fill-plated vias may be distributed to two adjacent different chips when cut into individual chips. The coil component 2000 according to the second embodiment has a structure in which the connecting conductors 710 and 720 extend to the side of the body 100, and the process may be simplified by reducing the number of via holes.

At least a portion of cross-sections of the connecting conductors 710 and 720, parallel to the first surface 101 of the body, may have a shape of a segment of a circle such as a semicircular shape. For example, at the time of cutting into individual chips, the fill-plated vias may be split in half and distributed to two adjacent chips that are different from each other. Since the cross-section of the via parallel to the first surface before cutting into individual chips is circular, the cross-sections of the connecting conductors 710 and 720 after cutting may be semi-circular. However, the present disclosure is not limited thereto, and a portion of the fill-plated via may be partially removed at the time of cutting of individual chips, and thus, may not be distributed to two adjacent chips. In this case, as illustrated in FIG. 18 below, a cross-section of the tapered region T of the connecting conductors 710 and 720, parallel to the first surface 101 of the body 100, may have a scallop shape.

The body 100 may include a recess in which the connecting conductors 710 and 720 are disposed. As described above, the via hole may be formed across two adjacent chips different from each other, and a portion of the via hole formed in either chip may be referred to as a recess. The recess is formed by processing the body 100 and the coil 300 by drilling and then distributing fill-plated vias to different adjacent chips through a dicing process.

One side surface of the connecting conductors 710 and 720 and one side surface of the body may form a coplanar surface. In detail, the first connecting conductor 710 has one side surface extending to the third surface 103 of the body 100, and one side surface of the first connecting conductor 710 may be substantially coplanar with the third surface 103 of the body 100. The second connecting conductor 720 has one side surface extending to the fourth surface 104 of the body 100, and one side surface of the second connecting conductor 720 may be substantially coplanar with the fourth surface 104 of the body 100. In this case, one side surface of the first and second connecting conductors 710 and 720 may be a cut surface of a fill-plated via.

An aspect ratio of the recess of the coil component 2000 according to the second embodiment may be measured as follows.

In the case in which at least a portion of the cross-section of the connecting conductors 710 and 720, parallel to the first surface 101 of the body, has a semicircular shape, an average value of a maximum radius and a minimum radius of cross-sections in the tapered region T parallel to the first surface 101 may be referred to as ‘a’. Regarding the method of measuring the average value, the description in the first embodiment may be inferred and applied.

FIGS. 18A and 18B each show a diagram illustrating connecting conductors of the coil component 2000 according to the second embodiment. In detail, FIG. 18A illustrates the second connecting conductor 720 in the case in which the connecting conductors 710 and 720 have a vertical region V, and FIG. 18B illustrates the second connecting conductor 720 in the case in which the second connecting conductors 710 and 720 do not have the vertical region (V).

Referring to FIGS. 18A and 18B, a cross-section of the tapered region T of the connecting conductors 710 and 720, parallel to the first surface 101 of the body 100, may have a scallop shape. When one end surface and the other end surface of the tapered region T, parallel to the first surface 101 of the body 100, at both ends thereof in the first direction are referred to as S1 and S2, respectively, maximum values of lengths between the arcs and the chords in the second direction in the end surfaces S1 and S2 are referred to as a1 and a2, respectively. In this case, the average value of a1 and a2 is referred to as a, and the length of the tapered region T in the first direction is referred to as c. The aspect ratio of the recess is defined as c/a, and as in the first embodiment, c/a may have a value of 0.18 or more and 12.25 or less.

The ‘a’ value of the coil component 2000 according to the present embodiment may be measured as follows. Among cross-sections of the coil component in the first direction (X-direction) and second direction (Y-direction), cross-section samples passing through the centers of the connecting conductors 710 and 720 are taken. The cross-section passing through the center of the connecting conductors 710 and 720 refers to a cross-section passing through the center of one end surface and the other end surface (circle) of the via having a tapered region before cutting, and the description in the first embodiment may be inferred and applied. A maximum value of the length between the arc and the chord of the connecting conductors 710 and 720, in the second direction, is obtained by analyzing the collected cross-sectional sample with an optical microscope or a scanning electron microscope (SEM) image.

Table 3 below is a table illustrating c/a ranges of the connecting conductors 710 and 720 of the coil component according to the second embodiment. Depending on the chip size (0804, 1007, 1412), the location of the connecting conductor processing, and the thickness of the cover (thickness of the body in which the coil is embedded), various c/a ranges may be provided as illustrated in Table 3 below. c1, c2, and c3 are various examples of the length c of the tapered region T in the first direction. In this case, 0804 corresponds to a coil component with length and width of 0.8 mm and 0.4 mm, respectively. In this case, 1007 corresponds to a coil component having length and width of 1.0 mm and 0.7 mm, respectively. In this case, 1412 corresponds to a coil component with length and width of 1.4 mm and 1.2 mm, respectively.

TABLE 3

| | | Based on central | | | Based on coil | | | Based on coil | | | |
|---|---|---|---|---|---|---|---|---|---|---|---|
| Chip | | design value | | | maximum inner | | | maximum outer | | | c/a |
| Size | | processing | | | shift | | | shift | | | Range |
| 0804 | a₁ | 115 | | | 142.6 | | | 65 | | | 0.28- |
| | a₂ | 65 | | | 92.6 | | | 15 | | | 5.25 |
| | a | 90 | | | 117.6 | | | 40 | | | |
| | | c1 | c2 | c3 | c1 | c2 | c3 | c1 | c2 | c3 | |
| | c (when | 33 | 67 | 100 | 33 | 67 | 100 | 33 | 67 | 100 | |
| | cover t | | | | | | | | | | |
| | is 100 μm) | | | | | | | | | | |
| | c/a | 0.37 | 0.74 | 1.11 | 0.28 | 0.57 | 0.85 | 0.83 | 1.68 | 2.50 | |
| | | c1 | c2 | c3 | c1 | c2 | c3 | c1 | c2 | c3 | |
| | c (when | 50 | 100 | 150 | 50 | 100 | 150 | 50 | 100 | 150 | |
| | cover t | | | | | | | | | | |
| | is 150 μm) | | | | | | | | | | |
| | c/a | 0.56 | 1.11 | 1.67 | 0.43 | 0.85 | 1.28 | 1.25 | 2.50 | 3.75 | |
| | | c1 | c2 | c3 | c1 | c2 | c3 | c1 | c2 | c3 | |
| | c (when | 60 | 120 | 180 | 60 | 120 | 180 | 60 | 120 | 180 | |
| | cover t | | | | | | | | | | |
| | is 180 μm) | | | | | | | | | | |
| | c/a | 0.67 | 1.33 | 2.00 | 0.51 | 1.02 | 1.53 | 1.50 | 3.00 | 4.50 | |
| | | c1 | c2 | c3 | c1 | c2 | c3 | c1 | c2 | c3 | |
| | c (when | 70 | 140 | 210 | 70 | 140 | 210 | 70 | 140 | 210 | |
| | cover t | | | | | | | | | | |
| | is 210 μm) | | | | | | | | | | |
| | c/a | 0.78 | 1.56 | 2.33 | 0.60 | 1.19 | 1.79 | 1.75 | 3.50 | 5.25 | |
| 1007 | a₁ | 115 | | | 142.6 | | | 65 | | | 0.20- |
| | a₂ | 65 | | | 92.6 | | | 15 | | | 5.0 |
| | a | 90 | | | 117.6 | | | 40 | | | |
| | | c1 | c2 | c3 | c1 | c2 | c3 | c1 | c2 | c3 | |
| | c (when | 33 | 67 | 100 | 33 | 67 | 100 | 33 | 67 | 100 | |
| | cover t | | | | | | | | | | |
| | is 100 μm) | | | | | | | | | | |
| | c/a | 0.37 | 0.74 | 1.11 | 0.20 | 0.42 | 0.62 | 0.83 | 1.68 | 2.50 | |
| | | c1 | c2 | c3 | c1 | c2 | c3 | c1 | c2 | c3 | |
| | c (when | 50 | 100 | 150 | 50 | 100 | 150 | 50 | 100 | 150 | |
| | cover t | | | | | | | | | | |
| | is 150 μm) | | | | | | | | | | |
| | c/a | 0.56 | 1.11 | 1.67 | 0.31 | 0.62 | 0.93 | 1.25 | 2.50 | 3.75 | |
| | | c1 | c2 | c3 | c1 | c2 | c3 | c1 | c2 | c3 | |
| | c (when | 63 | 127 | 190 | 63 | 127 | 190 | 63 | 127 | 190 | |
| | cover t | | | | | | | | | | |
| | is 190 μm) | | | | | | | | | | |
| | c/a | 0.70 | 1.41 | 2.11 | 0.39 | 0.79 | 1.18 | 1.58 | 3.17 | 4.75 | |
| | | c1 | c2 | c3 | c1 | c2 | c3 | c1 | c2 | c3 | |
| | c (when | 50 | 100 | 200 | 50 | 100 | 200 | 50 | 100 | 200 | |
| | cover t | | | | | | | | | | |
| | is 200 μm) | | | | | | | | | | |
| | c/a | 0.56 | 1.11 | 2.22 | 0.31 | 0.62 | 1.24 | 1.25 | 2.50 | 5.00 | |
| 1412 | a₁ | 115 | | | 142.6 | | | 65 | | | 0.18- |
| | a₂ | 65 | | | 92.6 | | | 15 | | | 12.25 |
| | a | 90 | | | 117.6 | | | 40 | | | |
| | | c1 | c2 | c3 | c1 | c2 | c3 | c1 | c2 | c3 | |
| | c (when | 33 | 66 | 100 | 33 | 66 | 100 | 33 | 66 | 100 | |
| | cover t | | | | | | | | | | |
| | is 100 μm) | | | | | | | | | | |
| | c/a | 0.37 | 0.73 | 1.11 | 0.18 | 0.36 | 0.54 | 0.83 | 1.65 | 2.50 | |
| | | c1 | c2 | c3 | c1 | c2 | c3 | c1 | c2 | c3 | |
| | c (when | 32.5 | 65 | 130 | 32.5 | 65 | 130 | 32.5 | 65 | 130 | |
| | cover t | | | | | | | | | | |
| | is 130 μm) | | | | | | | | | | |
| | c/a | 0.36 | 0.72 | 1.44 | 0.18 | 0.35 | 0.70 | 0.81 | 1.63 | 3.25 | |
| | | c1 | c2 | c3 | c1 | c2 | c3 | c1 | c2 | c3 | |
| | c (when | 37.5 | 75 | 150 | 37.5 | 75 | 150 | 37.5 | 75 | 150 | |
| | cover t | | | | | | | | | | |
| | is 150 μm) | | | | | | | | | | |
| | c/a | 0.42 | 0.83 | 1.67 | 0.20 | 0.41 | 0.81 | 0.94 | 1.88 | 3.75 | |
| | | c1 | c2 | c3 | c1 | c2 | c3 | c1 | c2 | c3 | |
| | c (when | 106 | 211 | 317 | 106 | 211 | 317 | 106 | 211 | 317 | |
| | cover t | | | | | | | | | | |
| | is 317 μm) | | | | | | | | | | |
| | c/a | 1.17 | 2.35 | 3.52 | 0.57 | 1.14 | 1.71 | 2.64 | 5.28 | 7.93 | |
| | | c1 | c2 | c3 | c1 | c2 | c3 | c1 | c2 | c3 | |
| | c (when | 163 | 327 | 490 | 163 | 327 | 490 | 163 | 327 | 490 | |
| | cover t | | | | | | | | | | |
| | is 490 μm) | | | | | | | | | | |
| | c/a | 1.81 | 3.63 | 5.44 | 0.88 | 1.77 | 2.65 | 4.08 | 8.17 | 12.25 | |

Other details of the connecting conductors 710 and 720 of the coil component 2000 according to the second embodiment are substantially the same as those described above in the description of the first embodiment, and the description of the first embodiment may be applied equally. For example, various filling structures of connecting conductors may be provided as illustrated in FIGS. 12 to 14, and connecting conductors may be deformed to have side surfaces having different inclination angles as illustrated in FIG. 15.

In detail, the connecting conductors 710 and 720 may have a side surface perpendicular to the first surface 101 of the body 100, except for one side surface exposed to the third surface 103 or the fourth surface 104 of the body 100. In the connecting conductors 710 and 720, an area having a side surface perpendicular to the first surface 101 of the body 100, except for one side surface exposed to the third surface 103 or the fourth surface 104 of the body 100, may be referred to as a vertical region V as in the first embodiment.

The vertical region V may be disposed between the filling region F and the tapered region T to connect the filling region F and the tapered region T.

At least a portion of the vertical region V may be disposed in the concave portions D1 and D2. In the case of the second embodiment, the concave portions D1 and D2 may form portions of the recess. This is because, as described above, in the case of the second embodiment, the via hole may be formed across two adjacent chips, and a portion of the via hole formed on either chip may be referred to as a recess.

The connecting conductors 710 and 720 include curved surfaces, and the curved surfaces of the connecting conductors 710 and 720 may form portions of the filling regions F.

In the coil component 2000 according to the second embodiment, the insulating layer 600 covers the side surfaces of the connecting conductors 710 and 720 exposed from the body 100. As described above, the side surfaces of the first and second connecting conductors 710 and 720 extend to the third surface 103 and the fourth surface 104 of the body 100, respectively, and the insulating layer 600 is disposed on the extended side surfaces on respective surfaces.

Other contents are substantially the same as those described above in the description of the first embodiment, and thus, detailed descriptions are omitted.

### Third Embodiment

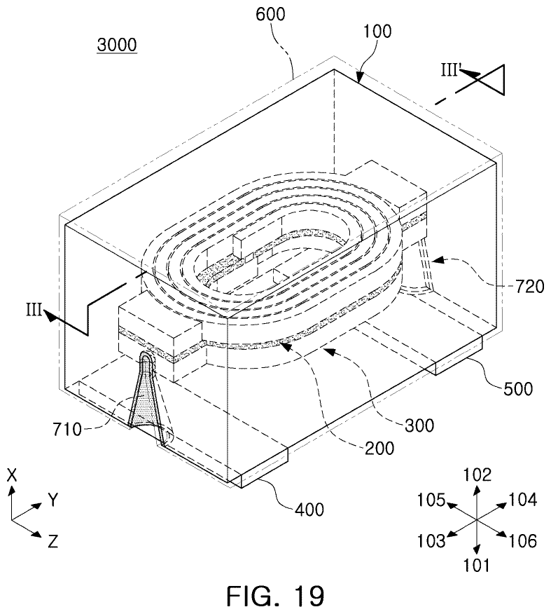

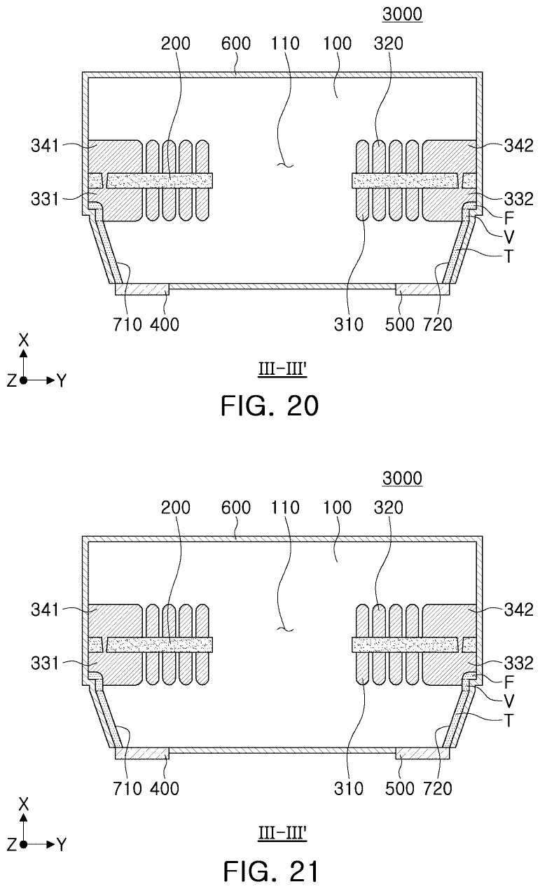

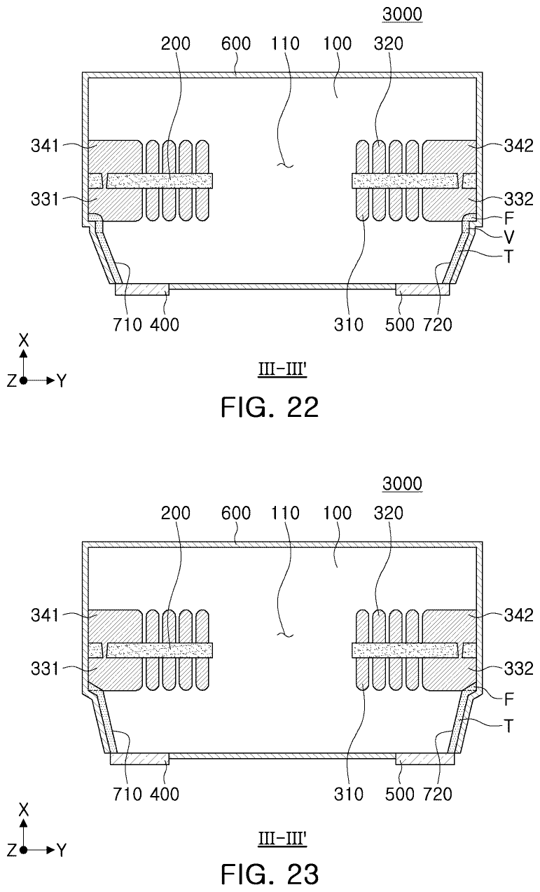

FIG. 19 is a schematic view of a coil component according to a third embodiment. FIGS. 20 to 22 are views corresponding to the cross-section taken along line III-III′ of FIG. 19 and illustrating various filling structures of the connecting conductor. FIG. 23 illustrates a modified example of the coil component according to the third embodiment of FIG. 19 and is a view corresponding to a cross-section taken along line III-III′ of FIG. 19.

Hereinafter, with reference to FIGS. 19 to 23, a coil component 3000 according to the third embodiment will be described, and differences from the coil components 1000 and 2000 according to the first and second embodiments will be described in detail.

In the case of the coil component 3000 according to the third embodiment, the connecting conductors 710 and 720 partially fill the recess of the body 100. The connecting conductors 710 and 720 may be formed along the surface of the recess of the body 100, and may fill only a portion of the recess.

The connecting conductors 710 and 720 of the coil component 3000 according to the third embodiment are formed as follows. In the case of the third embodiment, unlike the first and second embodiments, the via hole may be partially plated instead of being completely filled. The partially plated vias may be cut and distributed to two adjacent chips that are different from each other, and connecting conductors 710 and 720 partially filling the recesses are formed.

In the case of the coil component 3000 according to the third embodiment, there is an advantage in that the amount of the conductive material filling the via hole may be significantly reduced.

The aspect ratio of the recess of the coil component 3000 according to the third embodiment may be obtained by inferring the method in the second embodiment. For example, the sample of the cross-section taken is analyzed with an optical microscope or a scanning electron microscope (SEM) image, and ‘a’ value may be obtained assuming the connecting conductors 710 and 720 in which the recess is completely plated.

Other contents are substantially the same as those described above in the description of the first and second embodiments, and thus, detailed descriptions are omitted.

As set forth above, according to an embodiment, the DC resistance (Rdc) value of the coil component may be reduced.

In addition, according to an embodiment, high inductance may be secured by significantly reducing loss of a magnetic material of the coil component.

While example embodiments have been illustrated and described above, it will be apparent to those skilled in the art that modifications and variations could be made without departing from the scope of the present disclosure as defined by the appended claims.

What is claimed is:

1. A coil component comprising:
a body including a first surface and a second surface opposing each other;
a coil disposed in the body and having a concave portion disposed in a portion of a surface of the coil;
an external electrode disposed on the first surface of the body; and
a connecting conductor connecting the coil and the external electrode,
wherein the connecting conductor includes a filling region disposed in at least a portion of the concave portion of the coil and a tapered region having a side surface inclined with respect to the first surface.

2. The coil component of claim 1, wherein the connecting conductor further comprises a vertical region having a side surface perpendicular to the first surface.

3. The coil component of claim 2, wherein the vertical region is disposed between the filling region and the tapered region and connects the filling region and the tapered region.

4. The coil component of claim 2, wherein at least a portion of the vertical region is disposed in the concave portion.

5. The coil component of claim 1, wherein the tapered region is connected to the external electrode.

6. The coil component of claim 1, wherein the connecting conductor includes a curved surface.

7. The coil component of claim 6, wherein the curved surface includes a portion of the filling region.

8. The coil component of claim 1, wherein one side surface of the connecting conductor extends to a side surface of the body.

9. The coil component of claim 8, wherein the connecting conductor includes a vertical region having a side surface perpendicular to the first surface.

10. The coil component of claim 9, wherein the vertical region is disposed between the filling region and the tapered region and connects the filling region and the tapered region.

11. The coil component of claim 9, wherein at least a portion of the vertical region is disposed in the concave portion.

12. The coil component of claim 8, wherein the connecting conductor includes a curved surface.

13. The coil component of claim 12, wherein the curved surface includes a portion of the filling region.

14. The coil component of claim 8, wherein the body includes a recess in which the connecting conductor is disposed.

15. The coil component of claim 14, wherein one side surface of the connecting conductor and one side surface of the body have a coplanar surface.

16. The coil component of claim 14, wherein the connecting conductor partially is disposed in the recess of the body.

17. The coil component of claim 8, further comprising an insulating layer covering a side surface exposed from the body in the connecting conductor.

18. The coil component of claim 8, wherein at least a portion of a cross section of the connecting conductor parallel to the first surface has a shape of a segment of a circle.

19. The coil component of claim 18, wherein the shape of the segment of the circle is a semicircular shape.

20. The coil component of claim 1, wherein the filling region includes a first side surface inclined with respect to the first surface, and the tapered region includes a second side surface inclined with respect to the first surface.

21. The coil component of claim 20, wherein the first side surface and the second side surface have different slopes with respect to the first surface.

22. The coil component of claim 21, wherein the first side surface has a lower slope with respect to the first surface than a slope of the second side surface.

23. The coil component of claim 1, wherein when a direction in which the first and second surfaces oppose each other is defined as a first direction, an average value (a) of a maximum diameter and a minimum diameter of a cross-section of the tapered region parallel to the first surface and a length (c) of the tapered region in the first direction satisfy 0.18≤c/a≤12.25.

24. The coil component of claim 1, wherein the connecting conductor includes a plating layer.

25. The coil component of claim 1, wherein the external electrode includes a first conductive layer, a second conductive layer, and a third conductive layer sequentially disposed on the first surface of the body.

26. The coil component of claim 25, wherein the first conductive layer is a conductive resin layer, and
the first and second conductive layers are plating layers.

27. The coil component of claim 25, wherein the first to third conductive layers are plating layers.

28. The coil component of claim 1, further comprising a support member disposed within the body and having one surface and the other surface facing the first and second surfaces of the body, respectively,
wherein the coil includes a first coil disposed on the one surface of the support member and a second coil disposed on the other surface of the support member, and
the external electrode includes a first external electrode and a second external electrode connected to the first and second coils, respectively.

29. The coil component of claim 28, further comprising a first via penetrating the support member and connecting one region of an innermost turn of the first coil and one region of an innermost turn of the second coil.

30. The coil component of claim 28, wherein the coil further includes a first lead-out portion disposed on the one surface of the support member, connected to the first coil and having a first concave portion, and a second lead-out portion disposed on the one surface of the support member, connected to the second coil and having a second concave portion, and
the connecting conductor includes a first connecting conductor connecting the first lead-out portion and the first external electrode, and a second connecting conductor connecting the second lead-out portion and the second external electrode.

31. The coil component of claim 30, wherein based on a direction from the first lead-out portion to the second lead-out portion, the first connecting conductor is connected to the first lead-out portion at a more inner side than a center line of the first lead-out portion, and
based on a direction from the second lead-out portion to the first lead-out portion, the second connecting conductor is connected to the second lead-out portion at a more inner side than a center line of the second lead-out portion.

32. The coil component of claim 31, wherein the first connecting conductor is connected to a side surface of the first lead-out portion facing an inner turn of the first coil, and
the second connecting conductor is connected to a side surface of the second lead-out portion facing the first coil.

33. The coil component of claim 30, wherein, when a direction in which the first and second surfaces face each other is defined as a first direction, and a direction in which the first and second connecting conductors face each other while being perpendicular to the first direction is defined as a second direction,
on one surface parallel to the first surface, the first and second connecting conductors are symmetrical with respect to a center point of the one surface or a center line perpendicular to the second direction.

34. The coil component of claim 30, wherein, when a direction in which the first and second surfaces face each other is referred to as a first direction, and a direction in which the first and second connecting conductors face each other while being perpendicular to the first direction is referred to as a second direction,
on one surface parallel to the first surface, the first and second connecting conductors have an asymmetrical structure with respect to a center point of the one surface or a center line perpendicular to the second direction.

35. A coil component comprising:
a body including a first surface and a second surface opposing each other and a side surface connecting the first surface and the second surface to each other;
a coil disposed in the body, and including one or more turns and a lead-out portion extending from an outermost one of the one or more turns to a side surface of the body;
an external electrode disposed on the first surface of the body;
a via hole disposed in the body and having a width increasing from the lead-out portion to the external electrode; and
a connecting conductor disposed in the via hole to connect the coil and the external electrode to each other.

36. The coil component of claim 35, wherein one side surface of the connecting conductor extends to the side surface of the body.

37. The coil component of claim 36, wherein the one side surface of the connecting conductor and the side surface of the body have a coplanar surface.

38. The coil component of claim 35, wherein the connecting conductor includes a curved side surface.

39. The coil component of claim 35, wherein at least a portion of a cross section of the connecting conductor parallel to the first surface has a shape of a segment of a circle.

40. The coil component of claim 35, wherein at least a portion of the connecting conductor has a shape of a truncated cone.

41. The coil component of claim 35, wherein the connecting conductor includes a plating layer.

42. The coil component of claim 35, wherein the via hole is partially filled with the connecting conductor.

43. The coil component of claim 35, wherein the via hole is entirely filled with the connecting conductor.
